(19) United States
(12) Patent Application Publication
(10) Pub. No.: US 2017/0138546 A1
(43) Pub. Date: May 18, 2017

(54) LENS, LIGHTING DEVICE AND LUMINAIRE

(71) Applicant: PHILIPS LIGHTING HOLDING B.V., EINDHOVEN (NL)

(72) Inventors: GUO JIANG WANG, EINDHOVEN (NL); YONG TANG, EINDHOVEN (NL)

(21) Appl. No.: 15/320,871

(22) PCT Filed: Jun. 25, 2015
(86) PCT No.: PCT/EP2015/064313

§ 371 Date: Dec. 21, 2016

(30) Foreign Application Priority Data
Jun. 27, 2014 (CN) PCT/CN2014/081053
Aug. 15, 2014 (EP) 14181103.4

(51) Int. Cl. F21K 9/62; F21V 7/22; F21V 5/00; F21V 5/04; F21V 7/00

(52) U.S. Cl. CPC F21K 9/62; F21V 5/04; F21V 7/0091; F21V 5/002; F21V 7/22; F21Y 2115/10

(57) ABSTRACT

A lens (100) is disclosed for a solid state lighting element (24). The lens comprises at least one light entry surface (110, 112) and a light exit surface (120) opposite the at least one light entry surface, the light exit surface comprising a regular pattern of microstructures (122) and a plurality of regular patterns of further microstructures (124), wherein each regular pattern of further microstructures is on a respective one of said microstructures. Such a lens (100) may achieve excellent colour mixing. A lighting device (10) including such a lens and a luminaire including such a lighting device (10) are also disclosed.

### FIELD OF THE INVENTION

The present invention relates to a lens for a solid state lighting element, the lens comprising at least one light entry surface and a light exit surface opposite the at least one light entry surface, the light exit surface comprising a regular pattern of microstructures.

The present invention further relates to a lighting device comprising such a lens.

The present invention yet further relates to a luminaire including such a lighting device.

### BACKGROUND OF THE INVENTION

With a continuously growing population, it is becoming increasingly difficult to meet the world's energy needs as well as to kerb greenhouse gas emissions such as carbon dioxide emissions that are considered responsible for global warming phenomena. These concerns have triggered a drive towards more efficient electricity use in an attempt to reduce energy consumption.

One such area of concern is lighting applications, either in domestic or commercial settings. There is a clear trend towards the replacement of traditional incandescent light bulbs, which are notoriously power hungry, with more energy efficient replacements. Indeed, in many jurisdictions the production and retailing of incandescent light bulbs has been outlawed, thus forcing consumers to buy energy-efficient alternatives, e.g. when replacing incandescent light bulbs.

A particular promising alternative is provided by lighting devices including solid state lighting (SSL) elements, which can produce a unit luminous output at a fraction of the energy cost of incandescent light bulbs. An example of such a SSL element is a light emitting diode.

A problem hampering the penetration of the consumer markets by such lighting devices is that consumers are used to the appearance of traditional lighting devices such as incandescent lighting devices and expect the SSL element-based lighting devices to have a similar appearance to these traditional lighting devices. However, as SSL elements act as a point source rather than an omnidirectional light source and may produce light of a particular colour rather than white light, additional measures are required to adjust the luminous output of the SSL elements such that the appearance of an SSL element-based lighting device resembles that of a traditional lighting device such as an incandescent lighting device.

In order to adjust the colour of the light produced by the SSL element, the luminous surface of the SSL element may be covered by a phosphor, for instance to convert the narrow spectrum luminous output of the SSL element into white light. A problem associated with the use of a phosphor is that different rays of light produced by the SSL element may travel along different paths having different path lengths through the phosphor. This causes so-called colour over angle variations in the luminous output of the lighting device, where light exiting the lighting device under different angles has different colours.

In order to address this problem, the lighting device may include a lens to mix the light exiting the phosphor in order to reduce the colour separation in the luminous output. For example, a lens may be provided having a light exit surface defined by a grid of convex or concave microstructures in order to provide this mixing function. Such microstructures act as facets such that light redirected by different facets may mix in order to improve the colour uniformity of the luminous output of the lighting device.

It is not straightforward to increase the colour mixing capabilities of such lenses, as will be explained with the aid of FIGS. 1 and 2, which schematically depict a convex lens facet (left side) and a concave lens facet (right side), onto which light under an angle with the optical axis (FIG. 1) and parallel to a vertical optical axis (FIG. 2) is incident, as indicated by the dashed arrows. The microstructure can be identified as the curved segment extending between line n-o and line m-o. As can be seen in FIGS. 1 and 2, both the convex and concave microstructures successfully scatter the incident light under relatively wide angles, thus facilitating the colour mixing of light scattered by different microstructures on the light exit surface of the lens. The amount of light scattering that can be achieved is governed by the curvature of the microstructure. However, the power of the curvature cannot be indefinitely increased. For the convex microstructure, a limiting scenario arises for rays that are incident at the left end point of the microstructure, i.e. that have incident angle ∠abo and an exit angle ∠mbc. For the concave microstructure, a limiting scenario arises for rays that are incident at the right end point of the microstructure, i.e. that have incident angle ∠abm and an exit angle ∠obc. Although larger scattering angles can be achieved by further increasing the curvature of the microstructures, the respective exit angles ∠mbc and ∠obc rapidly approaches 90° as a consequence, thereby dramatically increasing the probability of total internal reflection, which negatively impacts on the efficiency of the lens. Hence, such microstructured lenses typically implement a trade-off between efficiency and light scattering power.

### SUMMARY OF THE INVENTION

The present invention seeks to provide a lens for a solid state lighting element that has improved colour mixing capabilities.

The present invention further seeks to provide a lighting device including such a lens.

The present invention yet further seeks to provide a luminaire including such a lighting device.

According to an aspect, there is provided a lens for a solid state lighting element, the lens comprising at least one light entry surface and a light exit surface opposite the at least one light entry surface, the light exit surface comprising a regular pattern of microstructures and a plurality of regular patterns of further microstructures, wherein each regular pattern of further microstructures is on a respective one of said microstructures.

It has been found that the scattering power of such a colour-mixing lens can be significantly improved without significantly increasing total internal reflection by providing a pattern of further microstructures on the surface of each microstructure.

The lens may be a total internal reflection lens to maximize the amount of light exiting the light exit surface of the lens.

In an embodiment, the regular pattern of microstructures may be a honeycomb pattern to achieve a closely packed grid of microstructures.

The regular pattern of further microstructures may be a honeycomb pattern to achieve a closely packed grid of further microstructures on each microstructure.

Each microstructure and/or each further microstructure may have a curved surface, such as a convex surface or a concave surface in order to achieve uniform scattering characteristics.

The lens may further comprise a cavity for receiving the luminous output from a solid state lighting element, wherein said cavity is delimited by the light entry surface and a further light entry surface extending between the light entry surface and an outer surface of the collimating lens. The outer surface may taper outwardly from the further light entry surface towards the light exit surface in order to achieve the desired reflective characteristics, e.g. total internal reflection.

The lens may be made of an optical grade polymer such as polycarbonate, poly (ethylene terephthalate) or poly (methyl methacrylate). This has the advantage that the lens can be manufactured at low cost, e.g. by molding techniques.

According to another aspect, there is provided a lighting device comprising one or more embodiments of the aforementioned lens and a solid state lighting element arranged to produce a luminous output in the direction of the at least one light entry surface. Such a lighting device may benefit from limited colour over angle separation due to the presence of the inventive lens.

This may particularly be the case if the solid state lighting element comprises a light emitting surface covered by a phosphor, e.g. to generate white light, as the colour mixing capabilities of the lens ensure that the colour over angle separation is cancelled out to a large extent if not totally.

The solid state lighting element may be a light emitting diode.

In an embodiment, the lighting device is a light bulb. Non-limiting examples of suitable bulb sizes include but are not limited to MR11, MR16, GU4, GU5.3, GU6.35, GU10, AR111, Par20, Par30, Par38, BR30, BR40, R20, R50 light bulbs and so on.

In accordance with another aspect of the present invention, there is provided a luminaire comprising the lighting device according to an embodiment of the present invention. Such a luminaire may for instance be a holder of the lighting device or an apparatus into which the lighting device is integrated.

### BRIEF DESCRIPTION OF THE DRAWINGS

Embodiments of the invention are described in more detail and by way of non- limiting examples with reference to the accompanying drawings, wherein:

FIG. 1 schematically depicts an optical principle of a convex and concave microstructure respectively;

FIG. 2 schematically depicts another optical principle of a convex and concave microstructure respectively;

FIG. 3 schematically depicts a cross-section of a lens according to an embodiment;

FIG. 4 schematically depicts a top view-section of the lens of FIG. 3;

FIG. 5 schematically depicts a cross-section of a lens according to another embodiment;

FIG. 6 schematically depicts an optical principle of a lens according to embodiments;

FIG. 7 schematically depicts a cross-section of a lighting device according to an embodiment; and

FIG. 8 schematically depicts a cross-section of a lighting device according to another embodiment.

### DETAILED DESCRIPTION OF THE EMBODIMENTS

It should be understood that the figures are merely schematic and are not drawn to scale. It should also be understood that the same reference numerals are used throughout the figures to indicate the same or similar parts.

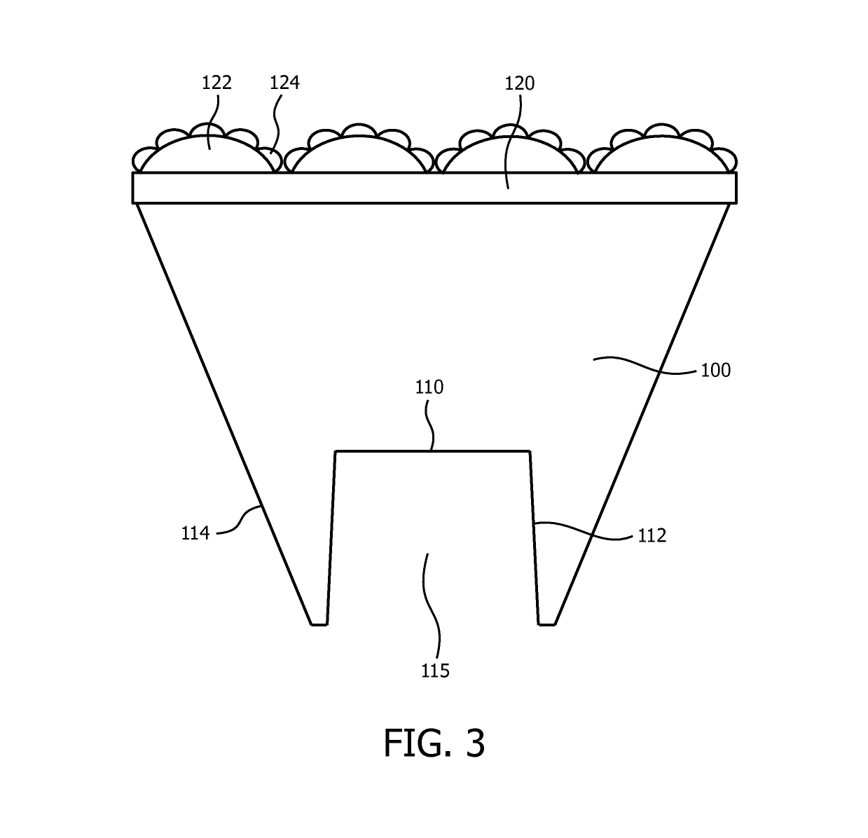

FIG. 3 schematically depicts a cross-section of a lens 100 according to an embodiment. The lens 100 comprises a cavity 115 delimited by a first light entry surface 110 and a further light entry surface 112 that extends from the first light entry surface 110 towards an end point of the lens 100. In the end point, the further light entry surface 112 adjoins an outer surface 114 of the lens 100, which outer surface 114 extends from the end point to a light exit surface 120 of the lens 100. It will be understood that it is equally feasible to replace the end point by an end segment, wherein the end segment extends from the further light entry surface 112 to the outer surface 114. It should be understood that the light entry surfaces 110, 112 are shown as planar surfaces by way of non-limiting example only. These surfaces may take any suitable shape, e.g. a curved surface such as a convex or concave surface.

The outer surface 114 may taper outwardly from the end point to the light exit surface 120 such that the width of the lens 100 increases towards the light exit surface 120. For instance, the outer surface 114 may be angled such that light entering the lens 100 through the first light entry surface 110 or the further light entry surface 112 and that is incident on the outer surface 114 is reflected by the outer surface 114 towards the light exit surface 120. In an embodiment, the outer surface 114 is arranged to reflect all such incident light towards the light exit surface 120, thereby providing a total internal reflection lens 100. Although the first light entry surface 110, the further light entry surface 112 and the outer surface 114 are depicted as planar surfaces, it should be understood that at least some of these surfaces may be curved, as previously mentioned. In addition, the outer surface 114 may be a freeform surface, a curved surface and so on.

The light exit surface 120 is typically arranged opposite the first light entry surface 110 such that the light exit surface 120 and the first light entry surface 110 are separated by a portion of the lens material. The light exit surface 120 comprises a plurality of microstructures 122 that are typically arranged in a regular pattern such as a grid. The microstructures 122 are scattering microstructures that scatter light exiting the lens 100 in different directions. In an embodiment, the microstructures 122 may be curved microstructures, i.e. microstructures having a curved surface. The curved surface may be a spherical surface or an aspherical surface.

Each microstructure 122 carries a plurality of further microstructures 124, which further microstructures may be arranged in a regular pattern such as a grid on the surface of the microstructure 122. The further microstructures 124 are scattering microstructures that scatter light exiting the lens 100 in different directions. In an embodiment, the further microstructures 124 may be curved microstructures, i.e. microstructures having a curved surface. The curved surface may be a spherical surface or an aspherical surface. In other words, each microstructure 122 has a surface defined by a plurality of further microstructures 124 rather than a continuous surface extending from a first end point to a second end point on the light exit surface 120; each microstructure 122 defines the light exit surface built up by multiple facets, each facet corresponding to one of the further microstructures 124. For instance, instead of having a surface defined by a single curvature, each microstructure 122 may have a light exit surface defined by a plurality of adjoining curvatures, i.e. by a plurality of further microstructures 124.

As will be explained in more detail later, the provision of the further microstructures 124 on the surface of the microstructure 122 improves the colour mixing capability of the lens 100 without suffering a substantial total internal reflection penalty.

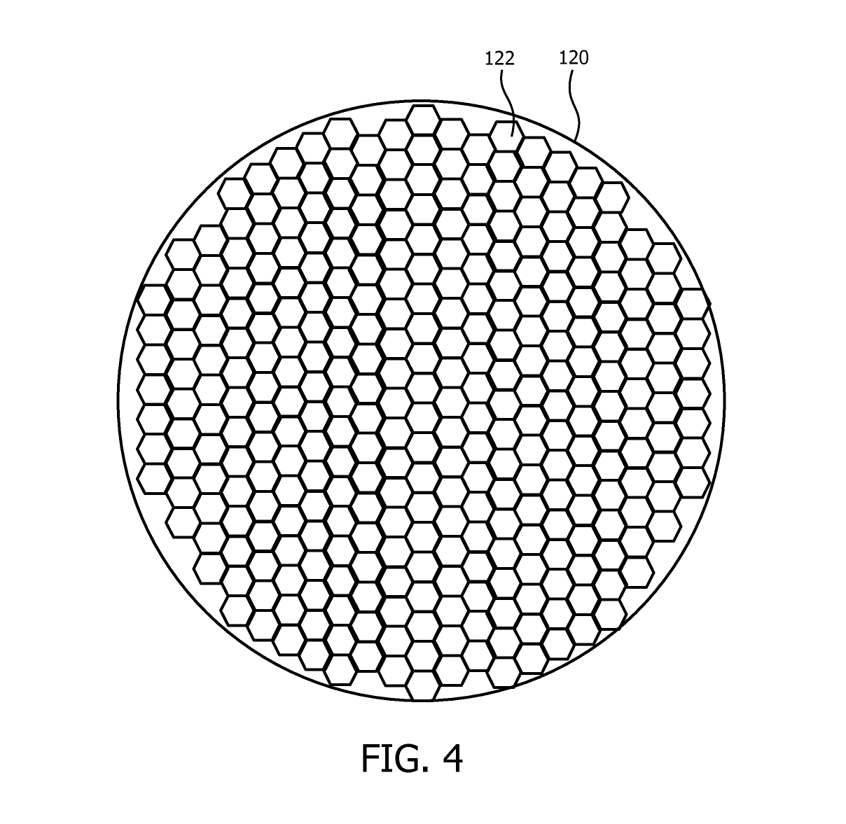

The microstructures 122 and/or the further microstructures 124 may be arranged in any suitable regular pattern. In an embodiment, the microstructures 122 and/or the further microstructures 124 may be arranged in a honeycomb pattern as shown in FIG. 4. This has the advantage that a particularly high density of microstructures 122 and/or further microstructures 124 may be achieved as each edge portion of each (internal) microstructure contacts an edge portion of a neighbouring microstructure.

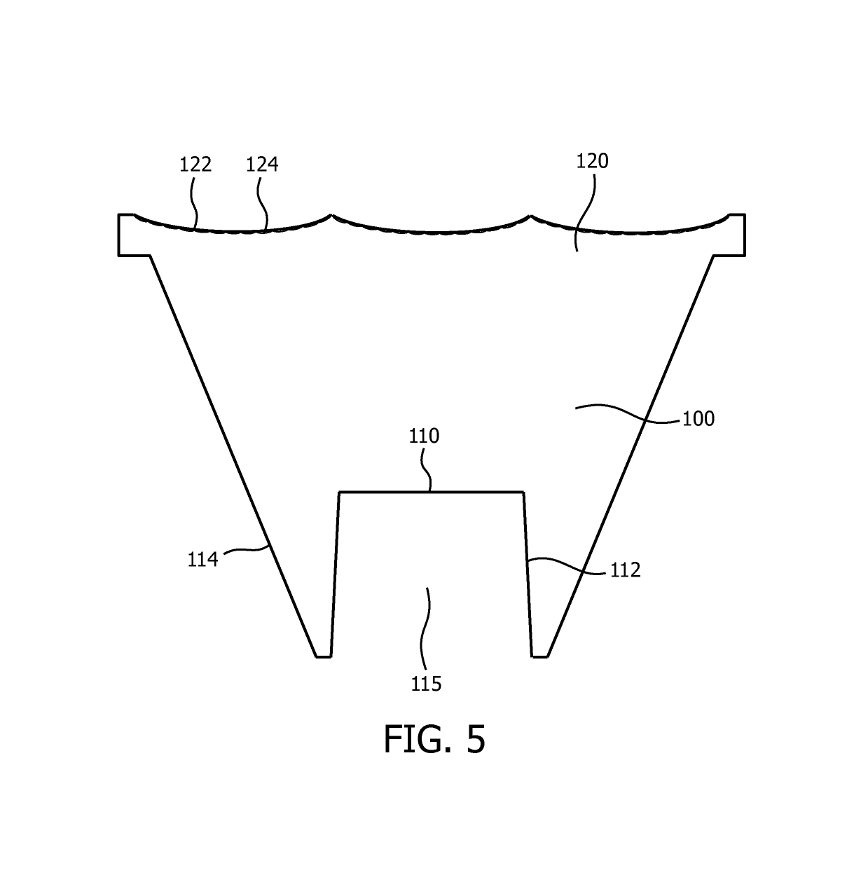

As shown in FIG. 3, the microstructures 122 and the further microstructures 124 are convex microstructures. However, it is equally feasible that the microstructures 122 and the further microstructures 124 are concave microstructures as shown in FIG. 5. Alternatively, the microstructures 122 may be convex microstructures and the further microstructures 124 may be concave microstructures, or the microstructures 122 may be concave microstructures and the further microstructures 124 may be convex microstructures. It is noted that in FIG. 3 some of the dimensions of the microstructures 122 and the further microstructures 124 have been exaggerated for the sake of clarity.

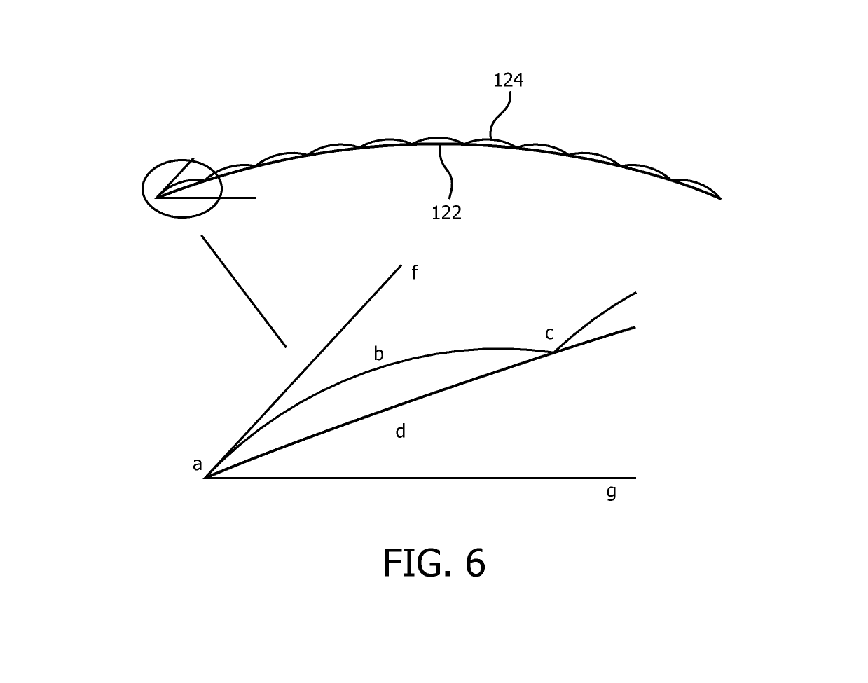

The optical principle of the lens 100 will now be explained in further detail with the aid of FIG. 6, which depicts a surface portion of a microstructure 122 carrying a plurality of further microstructures 124. A convex microstructure 122 carrying a plurality of convex further microstructures 124 is shown by way of non-limiting example; the same principle applies to a concave microstructure 122 carrying a plurality of concave further microstructures 124. According to an embodiment, the approximated linear surface segment a-d-c of the microstructure 122 is replaced by a curved surface segment a-b-c, i.e. by a further microstructure 124, here shown as a convex microstructure by way of non-limiting example. This locally increases the curvature of the surface of the microstructure 122 and divides the surface of the microstructure 122 into a plurality of such curved segments, which preferably are adjoining segments.

The curved further microstructures 124 locally increase the power of the microstructure 122 as the increased surface curvature increases the angle of a light ray exiting the microstructure 122, thereby increasing the colour mixing capability of the microstructures 122 of the lens 100, for instance because the different coloured light originating from neighbouring microstructures 122 can be more effectively mixed. At the same time, the further microstructures 124 are less likely to internally reflect a light ray travelling through the microstructure 122. This can be understood as follows.

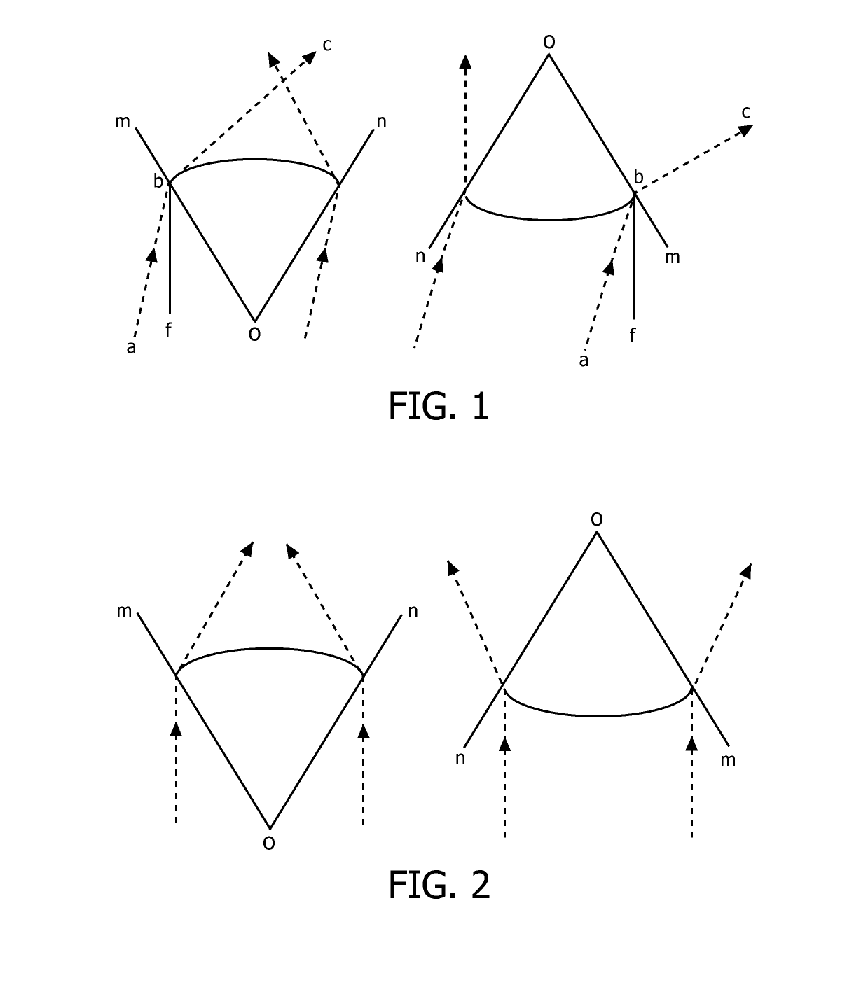

As previously explained with the aid of FIGS. 1 and 2, a worst optical performance scenario can occur when light rays are incident on the left end point of a convex microstructure 122 or are incident on the right end point of a concave microstructure 122. This is because the total internal reflection risk is highest for these scenarios. The inclusion of the further microstructures 124 on the surface of each microstructure 122 reduces this risk. The below equation (1) can be used to calculate a suitable curvature of the further microstructure 124. This expression is applicable for both convex and concave further microstructures 124.

η2=asin(1/Rᵢ)−asin((sin(0.5δ))/Rᵢ)−η1−γ (1)

In equation (1):

η 2 is the end point tangent line incline angle ∠fac of the further microstructure 124 shown in FIG.6. The angle η2 represents the further microstructure 124 curvature; the bigger the angle η2, the bigger the curvature becomes.

Ri is the refractive index of the material of the lens 100 at a chosen wavelength, e.g. 550 nm. The refractive index may be specified using any suitable number of relevant digits, e.g. two relevant digits.

δ is the target full width beam angle to be produced by the lens 100. δ can range from 10° to 60° in typical lighting applications.

η 1 is the end point tangent line incline angle ∠cag of the first microstructure 122 shown in FIG. 6. In some embodiments, η 1 is 10° or less although it should be understood that other values, e.g. more than 10° may also be contemplated.

γ is the security or design tolerance angle, which is used for reducing the risk of totally internal reflection. In some embodiments, γ may be selected from the range of 1° to 5° although it should be understood that other values, e.g. less than 1° or more than 5° may also be contemplated.

Consequently, by selecting the security angle as a function of the end point tangent line incline angle ∠cag of the first microstructure 122 and/or of δ, improved colour mixing can be achieved whilst ensuring that the total internal reflection risk at the light exit surface 120 of the lens 100 can be curtailed.

When δ is relatively large, for example around 60°, γ can be kept small, for example around 1°. On the other hand, when δ is small, for example around 10 degree, the lens 100 is required to achieve a higher degree of collimation, such that γ may be bigger, for around 5°.

The lens 100 may be made of any suitable material, such as glass or a polymer, preferably an optical grade polymer. Non-limiting examples of such polymers include polycarbonate (PC), poly (methyl methacrylate) (PMMA) and poly ethylene terephthalate (PET), although it should be understood that the skilled person will be aware of many suitable polymer alternatives to these example polymers. Manufacturing the lens 100 in one of the aforementioned polymer materials has the advantage that the lens 100 can be manufactured in a straightforward and low-cost manner, for instance by moulding techniques such as injection moulding. This facilitates large scale production of the lens 100, which is an important consideration when the lens 100 is to be integrated in a lighting device such as a lighting device including one or more SSL elements. The lens 100 may have any suitable shape, such as a lens 100 including a circularly shaped light exit surface 120 as for instance shown in FIG. 4.

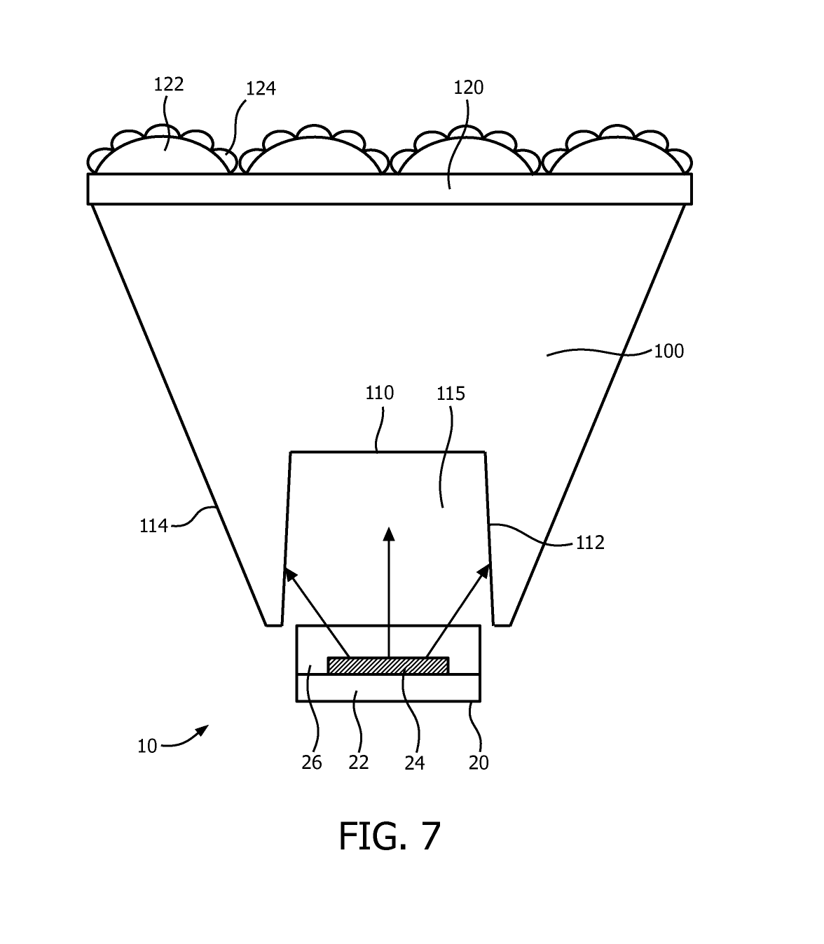

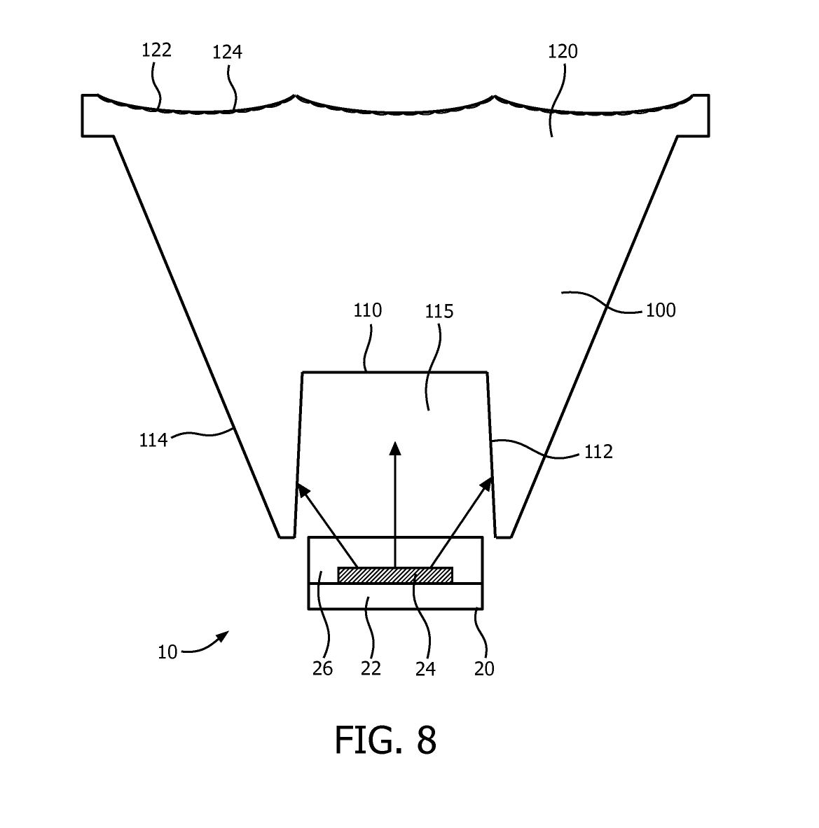

Embodiments of the lens 100 may be integrated into a lighting device 10 comprising a plurality of SSL elements 20, as shown in FIGS. 7 and 8. FIG. 7 schematically depicts a lighting device 10 including the previously described lens 100 with convex microstructures 122, 124 and FIG. 8 schematically depicts a lighting device 10 including the previously described lens 100 with concave microstructures 122, 124.

The lighting device 100 further comprises an SSL element assembly 20 including a carrier 22 such as a printed circuit board and/or heat sink carrying one or more SSL elements 24. The one or more SSL elements 24 may for instance be any suitable type of LEDs such as mid-power LEDs or high-power LEDs. The LEDs may comprise any suitable semiconductor material, e.g. an organic, polymer or inorganic semiconductor material as is well-known per se.

The one or more SSL elements 24 optionally may be embedded in a phosphor for converting the wavelength of the luminous output produced by the one or more SSL elements 24. For instance, the phosphor may be arranged to convert the luminous output of the one or more SSL elements 24 into white light. Any suitable phosphor may be used for this purpose, as such phosphorus are well-known per se this will not be explained in further detail for the sake of brevity only.

The SSL element assembly 20 is arranged such that the luminous output of the SSL element assembly 20 is directed into the cavity 115 of the lens 100 such that the luminous output can be coupled into the lens 100 through the first light entry surface 110 and/or the further light entry surface 112. In an embodiment, the upper surface of the SSL element assembly 20 is aligned with the end surface of the lens 100, as shown in FIG. 7 and FIG. 8. It should be understood that other arrangements are equally feasible, for instance the SSL element assembly 20 may be partially placed or placed in its entirety inside the cavity 115 such that the lens 100 envelopes the SSL element assembly 20. The lighting device 10 benefits from reduced colour separation in its output due to the fact that colour over angle artefacts are countered by the presence of the microstructures 122 and the further microstructures 124 at the light exit surface 120 of the lens 100 as previously explained.

In an embodiment, such a lighting device may be a light bulb. The shape and size of the light bulb is not particularly limited and any suitable shape and size may be contemplated. Non-limiting examples of such suitable sizes include MR11, MR16, GU4, GU5.3, GU6.35, GU10, AR111, Par20, Par30, Par38, BR30, BR40, R20, R50 light bulbs and so on. Such a lighting device may be advantageously integrated into a luminaire to provide a luminaire benefiting from being able to produce a luminous output having increased collimation. Any suitable type of luminaire may be contemplated, such as a ceiling down lighter, an armature, a freestanding luminaire, an electronic device including a lighting device, e.g. a cooker hood, fridge, microwave oven, and so on.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A lens for collecting and redistributing light emitted by a solid state lighting element, the lens comprising at least one light entry surface and a light exit surface opposite the at least one light entry surface, an outer surface extending from the light entry surface to the light exit surface, the outer surface being shaped such that substantially all incident light rays are reflected towards the light exit surface, and the light exit surface comprising a regular pattern of light scattering microstructures, wherein each light scattering microstructure carries a plurality of further light scattering microstructures arranged in a regular pattern.

2. The lens of claim 1, wherein the lens is a total internal reflection lens.

3. The lens of claim 1, wherein the regular pattern of microstructures is a honeycomb pattern.

4. The lens of claim 1, wherein the regular pattern of further microstructures is a honeycomb pattern.

5. The lens of claim 1, wherein each microstructure and/or each further microstructure has a curved surface.

6. The lens of claim 1, wherein each microstructure and/or each further microstructure has a convex surface.

7. The lens of claim 1, wherein each microstructure and/or each further microstructure has a concave surface.

8. The lens of claim 1, further comprising:
a cavity for receiving the luminous output from a solid state lighting element, wherein said cavity is delimited by the light entry surface and a further light entry surface extending between the light entry surface and an outer surface of the lens.

9. The lens of claim 1, wherein the collimating lens is made of an optical grade polymer.

10. The lens of claim 9, wherein the optical grade polymer is polycarbonate, poly (ethylene terephthalate) or poly (methyl methacrylate).

11. A lighting device comprising:
the lens of claim 1; and
a solid state lighting element arranged to produce a luminous output in the direction of the at least one light entry surface.

12. The lighting device of claim 11, wherein the solid state lighting element comprises a light emitting surface covered by a phosphor.

13. The lighting device of claim 11, wherein the solid state lighting element is a light emitting diode.

14. The lighting device of claim 11, wherein the lighting device is a light bulb.

15. A luminaire including the lighting device of claim 11.
